(19) United States
(12) Patent Application Publication
(10) Pub. No.: US 2018/0346240 A1
(43) Pub. Date: Dec. 6, 2018

(54) System for Connecting Containers

(71) Applicant: Busch Systems International Inc., Barrie (CA)

(72) Inventors: William Richard Bradbury, Barrie (CA); Christian Edward Bodyk, Angus (CA)

(21) Appl. No.: 15/994,325

(22) Filed: May 31, 2018

Related U.S. Application Data
(60) Provisional application No. 62/514,345, filed on Jun. 2, 2017.

(51) Int. Cl. B65F 1/00

(52) U.S. Cl. CPC B65F 1/0033; B65F 2220/108; B65F 2001/0086

(57) ABSTRACT

A system for connecting adjacent waste or recycling containers to each other is disclosed. The system includes a bracket and at least one locking member associated with the containers. The bracket is slidable in a first direction to slidably engage the at least one locking member until the bracket reaches a locking position. In the locking position, contact between co-operating surfaces of the at least one locking member and the bracket prevents movement of the bracket in at least a second direction opposite the first direction. A bracket and a locking member for use in a system for connecting two adjacent waste or recycling containers is also disclosed.

### CROSS-REFERENCE TO RELATED APPLICATION

This application claims the benefit of U.S. Provisional Patent Application No. 62/514,345 entitled “SYSTEM FOR CONNECTING CONTAINERS” filed Jun. 2, 2017, the entire content of which is incorporated herein by reference.

### FIELD

The present disclosure relates generally to a system for connecting adjacent containers. Specifically, the present disclosure relates to a system for connecting adjacent waste or recycling containers.

### BACKGROUND

Containers, such as waste or recycling containers, may be arranged in groups or clusters. For example, a recycling container for collecting paper products may be arranged adjacent to a recycling container for collecting plastic products. These adjacent containers may be connected to each other so that they remain in a desired configuration and can be moved as a single unit.

### SUMMARY

In one aspect of the present disclosure, there is provided a system for connecting adjacent waste or recycling containers to each other, the system comprising: a bracket and at least one locking member associated with the containers, wherein the bracket is slidable in a first direction to slidably engage the at least one locking member until the bracket reaches a locking position, and wherein, in the locking position, contact between co-operating surfaces of the at least one locking member and the bracket prevents movement of the bracket in at least a second direction opposite the first direction.

In some embodiments, the bracket is slidable to slidably receive the at least one locking member.

In some embodiments, the at least one locking member comprises at least two locking members, each container being associated with a respective one of the at least two locking members.

In some embodiments, the co-operating surfaces are defined on at least one locking element of the at least one locking member and on at least one blocking element of the bracket.

In some embodiments, the at least one locking element protrudes from the at least one locking member and wherein the at least one blocking element protrudes from the bracket.

In some embodiments, the co-operating surfaces include a locking surface on each of the at least one locking element and a respective blocking surface on each of the at least one blocking element, the locking surface abutting the respective blocking surface to prevent the movement of the bracket.

In some embodiments, the at least one locking element and the at least one blocking element comprise teeth that engage with each other in the locking position to prevent movement of the bracket.

In some embodiments, the at least one locking element each comprise a stepped ramp with an angled tread and a riser.

In some embodiments, the at least one blocking element each comprise a stepped ramp with an angled tread and a riser.

In some embodiments, the at least one locking member comprises at least two locking members, each locking member comprising a pin with a head and a pin body extending from the head, wherein the at least one locking element is disposed on the pin body.

In some embodiments, the pin body is insertable through a respective aperture in the container in a plurality of orientations and wherein the bracket is slidable into the locking position in only one of the plurality of orientations.

In some embodiments, the pin body comprises an end portion distal from the head and an intermediate portion between the end portion and the head, wherein the end portion has a first width transverse to the first direction and the intermediate portion has a second width transverse to the first direction, wherein the first width is larger than the second width, and wherein the at least one locking element is disposed on the end portion.

In some embodiments, the bracket comprises at least one slot to receive the at least one locking member, and wherein the at least one blocking element is arranged adjacent to the at least one slot.

In some embodiments, the at least one slot comprises at least two slots, wherein the bracket comprises a base and two extensions extending from opposing ends of the base to define a channel, and wherein each extension comprises at least one of the at least two slots.

In one aspect of the present disclosure, there is provided a bracket for use in connecting adjacent waste or recycling containers to each other, the bracket comprising: at least one slot extending in a first direction, the at least one slot for slidingly receiving at least one respective locking member associated with the containers until the bracket reaches a locking position; and at least one blocking element disposed on the bracket, the at least one blocking element defining at least one blocking surface for contacting at least one respective locking surface of the at least one locking member.

In some embodiments, the bracket further comprising a base having two opposing ends and an extension extending from each of the opposing ends to define a channel therebetween, wherein the at least one slot comprises at least two slots, wherein each extension comprises at least one of the at least two slots, and wherein at least one blocking element is arranged adjacent each of the at least two slots.

In some embodiments, the at least one blocking element protrudes from the bracket.

In some embodiments, the at least one blocking surface is for abutting the respective at least one locking surface to prevent movement of the bracket in a second direction opposite the first direction.

In some embodiments, the at least one blocking element each comprises a tooth for engaging a respective tooth of the at least one locking element in the locking position.

In some embodiments, the at least one blocking element each comprises a stepped ramp having an angled tread extending in the first direction and a riser.

Other aspects and embodiments of the present disclosure will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is a perspective view of two containers connected using a system according to one embodiment of the present disclosure;

FIG. 2 is a perspective exploded view of a portion of the system of FIG. 1;

FIG. 3 is a perspective view of one embodiment of a bracket for use in the system of FIG. 1;

FIG. 4 is a front view of the bracket of FIG. 3;

FIG. 5 is a rear view of the bracket of FIG. 3;

FIG. 6 is a top view of the bracket of FIG. 3;

FIG. 7 is a bottom view of the bracket of FIG. 3;

FIG. 8 is a cross-sectional view of the bracket of FIG. 3 taken along line 8-8 in FIG. 4;

FIG. 9 is a perspective view of one embodiment of a locking member for use in the system of FIG. 1;

FIG. 10 is a rear view of the locking member of FIG. 9;

FIG. 11 is a right side view of the locking member of FIG. 9; and

FIG. 12 is a cross-sectional view taken along line 12-12 in FIG. 4 when the bracket is in the locking position.

### DETAILED DESCRIPTION

According to one aspect of the present disclosure, there is provided a system for connecting adjacent waste or recycling containers to each other. Embodiments of the system include a bracket and at least one locking member associated with the containers. The bracket is slidable in a first direction to slidably engage the at least one locking member until the bracket reaches a locking position. In the locking position, contact between co-operating surfaces of the at least one locking member and the bracket prevents movement of the bracket in at least a second direction opposite the first direction.

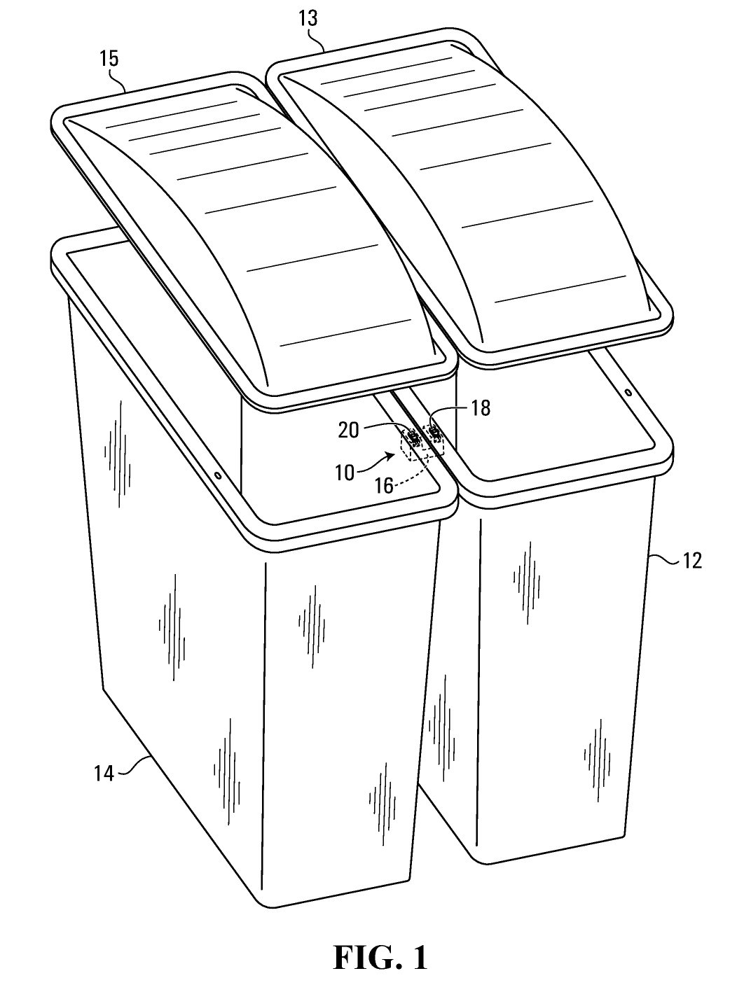

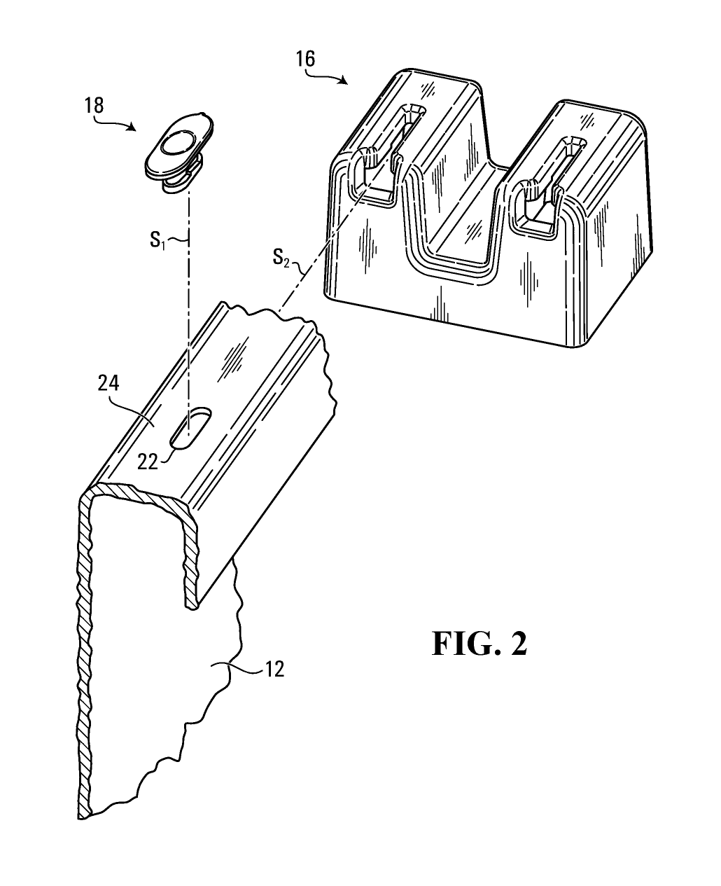

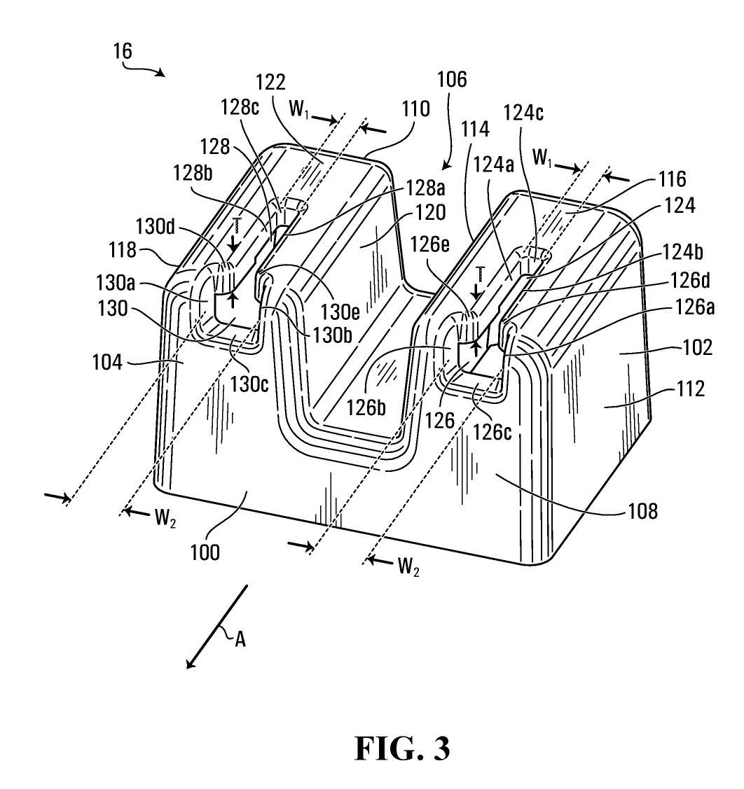

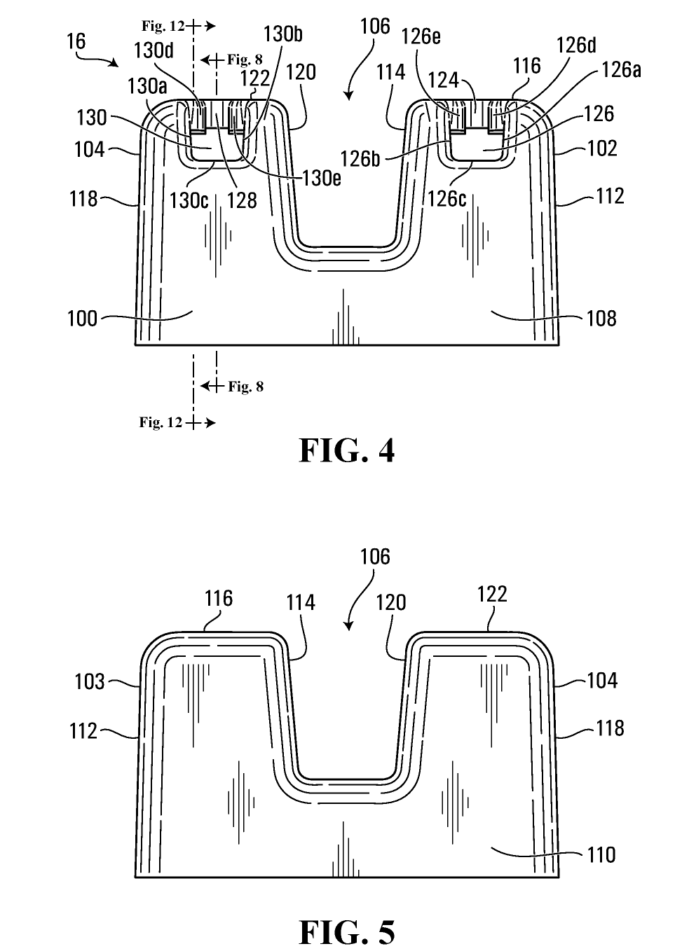

Referring to FIGS. 1 and 2, one embodiment of a system 10 for connecting adjacent containers 12 and 14 includes a bracket 16. In this embodiment, the at least one locking member comprises two locking members 18 and 20. The container 12 is associated with locking member 18 and the container 14 is associated with locking member 20. In FIG. 1, the bracket 16 is engaged with locking members 18 and 20 in a locking position. In the locking position, the containers 12 and 14 are connected so that they may act as a single unit. For example, they remain spaced apart from each other at a predetermined distance and may be lifted or moved as a group. In some embodiments, the containers may be so well connected with the system 10 that a user would be able to lift, shift or otherwise move both containers by only moving one of the containers.

FIG. 2 shows a close up of a portion of the container 12 in an exploded view to show how the bracket 16 and locking member 18 are brought together into the locking position in the embodiment being described. It will be understood that the same description applies correspondingly to the container 14, the locking member 20 and the bracket 16.

In the embodiment shown, locking member 18 is insertable through an aperture 22 in a rim 24 of the container 12 along the stippled line labelled S1. The bracket 16 is slidable into engagement with the locking members 18 and 20. Thus, after the locking members 18 and 20 have been inserted through their respective apertures, i.e. the locking member 18 has been inserted through aperture 22, the bracket 16 is slid in a first direction along the stippled line labelled S2 until it reaches the locking position. In the locking position, contact between co-operating surfaces of the locking members 18 and 20 and the bracket 16 prevents movement of the bracket in at least a second direction opposite the first direction.

In some embodiments, the co-operating surfaces are defined on at least one locking element of the at least one locking member and on at least one blocking element of the bracket. Embodiments of the locking and blocking elements will be described further below.

Container lids 13 and 15 are shown above containers 12 and 14, respectively. In the embodiment shown, the lids 13 and 15 are sized so that when they are placed on the containers 12 and 14 they cover locking members 18 and 20 and hide them from view. Similarly, if a user were to choose to use a container without connecting it to adjacent containers, its lid would cover the aperture 22 in the rim so that the aperture would not be visible.

In the embodiment shown, the at least one locking member comprises two locking members. However, in other embodiments, there may be only a single locking member that extends through an aperture in each container, where the locking elements are provided on ends of the locking member.

Furthermore, in the embodiment shown, the locking members 18 and 20 are insertable through respective apertures of the containers 12 and 14. However, other embodiments and configurations of the at least one locking member are possible and within the scope of the present disclosure. For example, if there are two or more locking members, the locking members may be integral with the containers so that they are not separate members but are formed, attached, affixed or otherwise made part of their respective containers. There may be multiple locking members associated with each container, the locking members of one container being of the same or different configuration.

Also, whether as a separate member or part of the containers, other configurations or placements of the locking members are possible. The locking members need not necessarily extend vertically. They may extend from other parts of the containers, such as the sidewalls of the containers, or other parts of the rim. Thus, for example, the locking members may extend out from each container substantially horizontally. They may also differ from one container to another, where for one container the locking member is inserted through an aperture but for the adjacent container, the locking member is integrally formed with the rim, the sidewall or another portion. Further, where multiple locking members are provided on one container, the placement, orientation and configuration of the locking members may differ or be the same.

It will be understood that, if the configuration of the locking members differ from the embodiment shown, then the bracket configuration would differ accordingly. For instance, where the locking members extend horizontally from the containers with the locking elements facing each other, the bracket could be configured such that the co-operating surfaces would be provided on opposing sides of the bracket facing away from each other such that the bracket is positioned between the locking members. Conversely, if there is only one locking member with locking elements on either end facing away from each other, the bracket could be configured to have the co-operating surfaces on opposing ends facing inward and towards each other such that the bracket envelopes or surrounds the locking member.

More generally, it is to be understood that the term “locking member” need not necessarily require a specific part or member that protrudes from or through the containers. In some embodiments, the locking members may be configured as slots or grooves in the containers, where the bracket is complementarily shaped so that it may be press fit into the slot or groove to provide the contact that prevents movement of the bracket. “Locking member” refers to any shape, component, form or other structure with one or more surfaces that co-operate with one or more counterpart surfaces of the bracket to prevent the bracket's movement.

Accordingly, numerous different configurations for the locking members and the bracket of the system may be used to allow the bracket to be slidable to slidingly receive the locking members until the bracket reaches a locking position. All such configurations are within the scope of the present disclosure.

Moreover, while only two containers are shown in FIG. 1, additional containers may be placed on either side of the containers 12 and 14 and multiple systems 10 may be used to connect the additional containers to each other and to the containers 12 and 14. Also, while the system 10 is shown connecting the containers 12 and 14 side-by-side, it will be understood that other configurations are possible and that the system 10 may be used to connect containers, for example, front-to-back, or in a different configuration. In such embodiments, the containers may also be configured differently than shown. For example, a container may have apertures for receiving locking members at multiple locations along the rim so that the user has a choice as to whether they wish to connect the containers side-by-side or in a different orientation.

Similarly, it will also be understood that multiple systems 10 may be used to connect adjacent containers. For example, there may be one system 10 near the front of the containers and one near the rear, in order to provide additional strengthening of the connection between the containers. This may allow the containers to better act as a single unit, e.g. when the connected containers are moved or arranged.

According to an aspect of the present disclosure, there is also provided a bracket for use in connecting adjacent waste or recycling containers to each other. In some embodiments, the bracket includes at least one slot extending in a first direction. The at least one slot is capable of slidingly receiving at least one respective locking member associated with the containers until the bracket reaches a locking position. The bracket further includes at least one blocking element disposed on the bracket. The at least one blocking element defines at least one blocking surface. In the locking position, contact between the at least one blocking surface and a respective at least one locking surface defined on the at least one respective locking element of the at least one locking member prevents the bracket from moving in a second direction opposite the first direction.

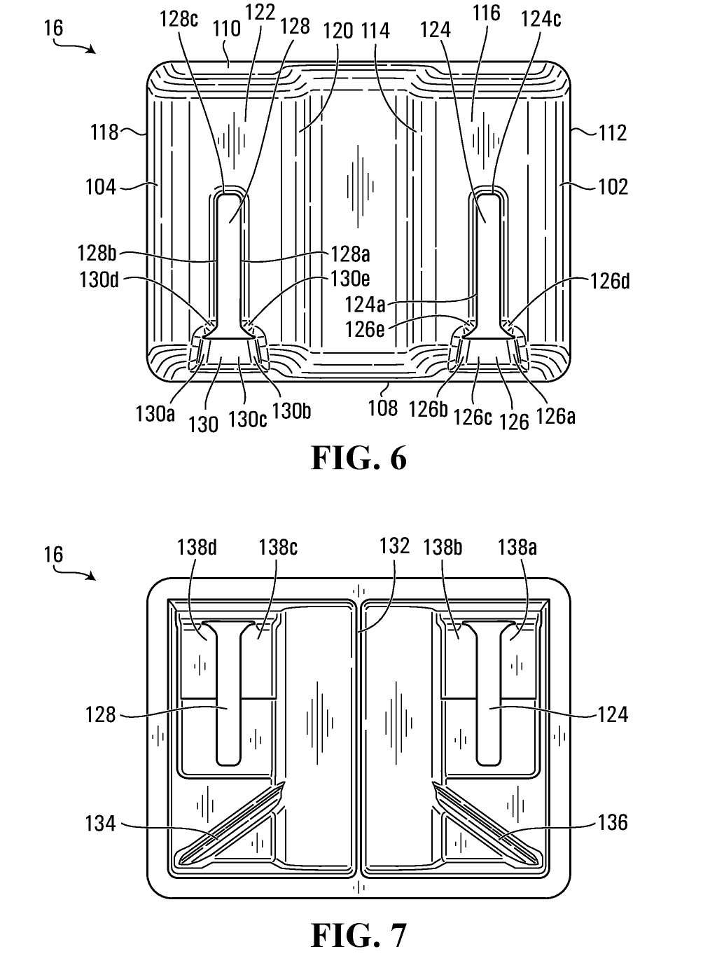

Referring to FIGS. 3 to 8, one embodiment of the bracket 16 for use in the system 10 will be described in more detail. The bracket 16 includes a generally rectangular base 100 with extensions 102 and 104 extending from opposing ends of the base 100 to define a channel 106 therebetween. The base 100 and the extensions 102 and 104 have a common front wall 108 and a common back wall 110. The extension 102 has an outer sidewall 112, an inner sidewall 114 and an upper wall 116. Similarly, the extension 104 has an outer sidewall 118, an inner sidewall 120 and an upper wall 122.

In some embodiments, the channel 106 is sized to receive portions of the containers, such as the outer lip of the rim 24.

In the embodiment shown, the at least one slot comprises at least two slots. The extension 102 has a slot 124 that extends along and through the upper wall 116 from a slot opening 126 located at an edge of the upper wall 116 and the front wall 108. Similarly, the extension 104 has a slot 128 that extends along and through the upper wall 122 from a slot opening 130 located at an edge of the upper wall 122 and the front wall 108. Each of the slots 124 and 128 extend parallel to each other and to the first direction, indicated by arrow A.

In the embodiment shown, the bracket 16 is symmetrical about a vertical plane parallel to the first direction, the plane extending through the middle of the base 100.

The slot 124 is defined and bounded by sidewalls 124a and 124b and rear wall 124c. Similarly, the slot 128 is defined and bounded by sidewalls 128a and 128b and rear wall 128c.

The slot opening 126 is defined and bounded by sidewalls 126a and 126b and bottom wall 126c. Shoulders 126d and 126e are situated at the transition between the slot opening 126 and the slot 124. Similarly, the slot opening 130 is defined and bounded by sidewalls 130a and 130b and bottom wall 130c. Shoulders 130d and 130e are situated at the transition between the slot opening 130 and the slot 128.

In the embodiment shown, sidewalls 126a, 126b and 130a, 130b are angled towards each other, respectively, as they extend to shoulders 126d, 126e and 130d, 130e.

Each of the upper walls 116 and 122 has a thickness T adjacent the slot openings 126 and 130. The slot openings 126 and 130 extend along the front wall 108 a distance greater than the thickness T.

Each of the slots 124 and 128 has a respective width W1 transverse to the first direction A, the width W1 being measured between the sidewalls 124a and 124b for the slot 124 and between the sidewalls 128a and 128b for the slot 128. Each of the slot openings 126 and 130 has a respective external width W2 transverse to the first direction. More specifically, for the slot opening 126, the width W2 is measured from the edge of the sidewall 126a and the front wall 108 to the edge of the sidewall 126b and the front wall 108. Similarly, for the slot opening 130, the width W2 is measured from the edge of the sidewall 130a and the front wall 108 to the edge of the sidewall 130b and the front wall 108.

The width W2 is greater than the width W1. Thus, the slot openings 126 and 130 act as “mouths” that receive the locking members 18 and 20 and guide them, via angled sidewalls 126a, 126b and 130a, 130b into slots 124 and 128 until the bracket reaches the locking position. This may improve usability of the system 10 since, as shown in FIG. 1, the point at which the bracket 16 first receives the locking members 18 and 20 may be situated underneath a portion of the containers 12 and 14 and out of view of the user.

In the embodiment shown, the bracket 16 is substantially hollow except for rib 132 and gussets 134 and 136, which may be provided to strengthen and stabilize the bracket.

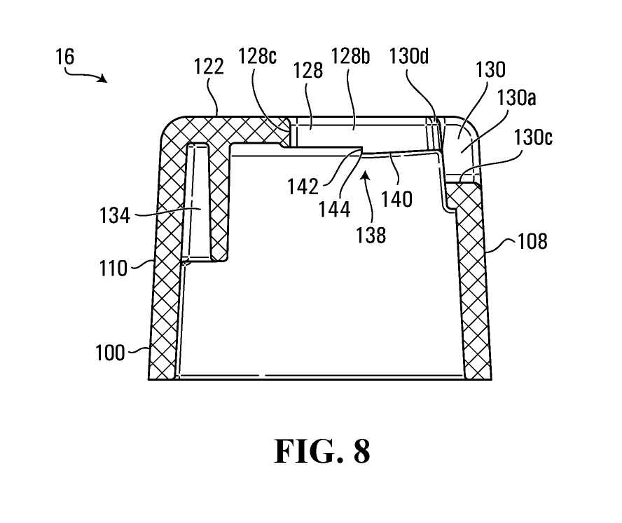

Referring now specifically to FIGS. 7 and 8, an embodiment of the at least one blocking element will be described. In some embodiments, at least one blocking element is arranged adjacent each slot. In the embodiment shown, blocking elements 138a to 138d are provided on the bottom sides of the upper walls 116 and 122 adjacent the slots 124 and 128. In the embodiment shown, a blocking element is provided on each side of the slots 124 and 128. Thus, the blocking elements 138a and 138b flank the slot 124 and the blocking elements 138c and 138d flank the slot 128. However, a different number and/or placement of blocking elements is possible.

In some embodiments, there may be only a single blocking element associated with each slot. The blocking elements may also be positioned at other locations. For example, they may be provided on the interior sidewalls of the bracket, or on the exterior of the bracket, such as on the upper walls 116 and 122. There may also be multiple blocking elements of different configurations that are used on the bracket in combination. For example, there may be a blocking element as shown provided on one side of each of the slots 124 and 128 and another type of blocking element provided on the other side of each of the slots 124 and 128.

Moreover, it will be understood that, if the placement and/or the configuration of the blocking elements differs from the embodiment shown, the configuration of the locking elements on the locking members will be modified accordingly to provide for the contact that prevents movement of the bracket in the second direction.

Furthermore, generally the term “blocking element” should be understood as encompassing any embodiments and mechanisms that achieve the described function even if different than the embodiments shown and described. For example, the blocking elements could be spring loaded, ratchet-type or other mechanisms. In some embodiments, the blocking element may simply be a slot, groove, nub or other protuberance.

In some embodiments, the at least one blocking element protrudes from the bracket. In some embodiment, the at least one blocking element each comprise a tooth that engages a respective tooth of the at least one locking element in the locking position.

In the embodiment shown, the blocking elements 138a to 138d each comprise a stepped ramp with an angled surface or tread 140 extending from the respective opening slot and a riser 142. The angled surface 140 is angled downward at a slight slope. In one embodiment, the slope forms an angle of 3.2 degrees with the top side of upper wall 116.

The blocking elements 138a to 138d each comprise at least one blocking surface 144 that, in the locking position, abuts a locking surface (described below) on each of the locking members to form the contact between the bracket 16 and the locking members 18 and 20, thereby preventing the movement of the bracket 16 in the second direction.

In the embodiment shown, the riser 142 comprises the blocking surface 144. However, it will be understood that in other embodiments of the blocking elements 138a to 138d, the blocking surface 144 may be positioned elsewhere or may not be present at all. Furthermore, only some of the above-described elements may be present without necessarily all elements being present. For example, the blocking elements may comprise a blocking surface but not a stepped ramp.

According to an aspect of the present disclosure, there is also provided a locking member. In the locking position, contact between the locking member and the bracket prevents movement of the bracket in the second direction. In some embodiments, the locking member includes locking elements that mate with the blocking elements of the bracket to form the contact.

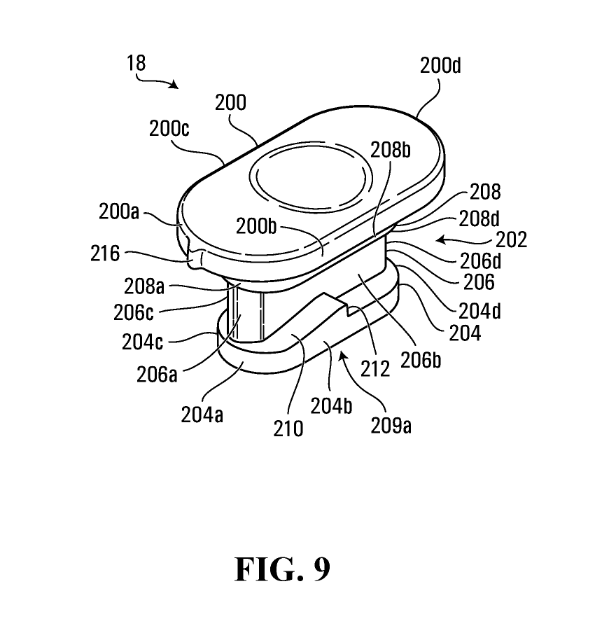

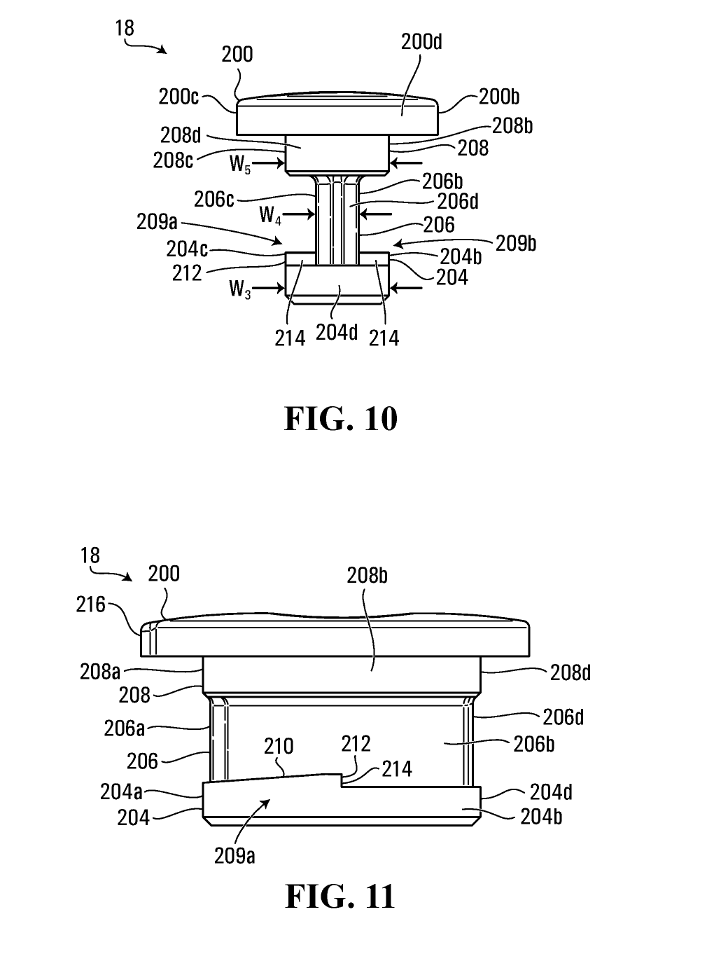

Referring now to FIGS. 9 to 11, locking members 18 and 20 will be described. In the embodiments shown, both locking members are identical and, for simplicity, only the locking member 18 will be described. However, as noted above in other embodiments according to the present disclosure, the locking members 18 and 20 are not necessarily identical or configured the same.

In the embodiment shown, the locking members 18 and 20 are configured as or comprise pins, which will also be referred to with reference numerals 18 and 20.

The pin 18 comprises a pin head 200, and a pin body 202 extending from the pin head 200. The pin body 202 is insertable through the aperture 22 of the container 12. The pin head 200 is configured to prevent the pin head 200 from passing through the aperture 22. Specifically, in the embodiment shown, the pin head 200 has a cross-section area parallel to the aperture that is larger than the area of the aperture. The pin head 200 is elongated in the first direction and has a generally oblong cross-section.

Other embodiments of the pin head are also possible. For example, the pin head might have just one dimension larger than a corresponding dimension of the aperture to prevent the pin head from passing through. Alternatively, the shapes of the pin head and aperture might be configured such that the pin head does not pass through, as is the case with, for example, a man-hole cover.

In some embodiments, the pin body 202 includes at least one protrusion that contacts a respective protrusion on the bracket in the locking position to prevent movement of the bracket in the second direction.

The pin body 202 comprises three portions: an end portion 204 distal from the pin head 200, an intermediate portion 206 between the end portion 204 and the pin head 200 and a neck portion 208 between the intermediate portion 206 and the pin head 200.

Each portion has an associated width transverse to the first direction. The end portion has a width W3, the intermediate portion a width W4, and the neck portion a width W5. The widths W3 and W5 are greater than the width W4, while the widths W3 and W5 are the same. Accordingly, as seen from the first direction, the pin body 202 has a stepped hour-glass shape with a narrowed mid-section.

Each of the neck portion 208, the intermediate portion 206 and the end portion 204 have a generally oblong shape elongated in the first direction, with a curved front end designated with an “a”, parallel sidewalls designated with a “b” and a “c”, and a curved rear end designated with a “d”.

Thus, for example, the pin head 200 has a curved front end 200a that merges into sidewalls 200b and 200c, which again merge into a rear end 200d.

In some embodiments, the co-operating surfaces that contact to prevent movement of the bracket are defined on at least one locking element. In some embodiments, the at least one locking element protrudes from the at least one locking member.

In the embodiment shown, on either side of the pin body 202, the end portion 204 comprises locking elements 209a and 209b. The locking elements 209a and 209b mate with blocking elements 138b and 138a to form the contact that prevents movement of the bracket 16.

In some embodiments, the at least one locking element each comprise a tooth that engages a respective tooth of the at least one blocking element to prevent movement of the bracket.

In some embodiments, the co-operating surfaces include a locking surface on each of the at least one locking element and a respective blocking surface (e.g. blocking surface 142) on each of the at least one blocking element, the locking surface abutting the respective blocking surface to prevent the movement of the bracket.

In the embodiment shown, the locking element 209a and 209b each comprise a stepped ramp with an angled surface or tread 210 extending from the front end 204a and a riser 212. The riser 212 comprises a locking surface 214 that, in the locking position, abuts the blocking surface 144 to prevent the movement of the bracket 16.

Other configurations of the locking elements are possible. For example, the locking elements are not necessarily provided on the end portion of the pin body and may be provided on other portions. As noted above, the locking elements may have numerous possible embodiments or configurations, depending on the configuration of the blocking elements so that, in the locking position, the blocking elements and the locking elements mate to form the contact that prevents movement of the bracket in the second direction. For example, the locking elements might be pins that are received in respective holes on the bracket, the holes acting as blocking elements.

Thus, generally, the term “locking element” is to be understood as encompassing any embodiments and mechanisms that achieve the described function even if different than the embodiments shown and described. For example, the locking elements could be spring loaded, ratchet-type or other mechanisms. In some embodiments, the locking element may be a groove, slot, nub or other protuberance.

The pin body 202 may be insertable through the aperture 22 in a plurality of orientations. For example, in the embodiment shown, due to the oblong shape of the pin 18 and the aperture 22, the pin body 202 is insertable through the aperture 22 in two orientations: one where the front end 200a of the pin head 200 faces the bracket 16 and the other where the rear end 200d of the pin head 200 face the bracket 16. However, if the pin body 202 and the aperture 22 had other cross-sectional shapes, for example circular, the pin 18 might be insertable in more than two orientations.

In some embodiments, as in the embodiment shown, there may be only some or one orientation of the plurality of orientations in which the bracket 16 may be slidable into the locking position. Therefore, the pin head 200 may include a protuberance 216 on the front end 200a to indicate the orientation in which the pin 18 should be inserted. Other forms of indication may also be possible, such as markings applied directly to the top side of the pin head 200.

Yet other configurations of the pin 18 are possible. For example, while the portions of the pin body 202 are stepped with respect to each other in the embodiment shown, the portions may continuously or smoothly transition into each other. There may also be a different number of portions and the dimensions and proportions may vary. The shape and configuration of the locking member will differ for different embodiments of the bracket, such that the bracket and locking members function together in the locking position to prevent movement of the bracket in the second direction.

In general, the bracket acts as a slide lock that is capable of slidingly receiving the at least one locking member until the bracket reaches a locking position.

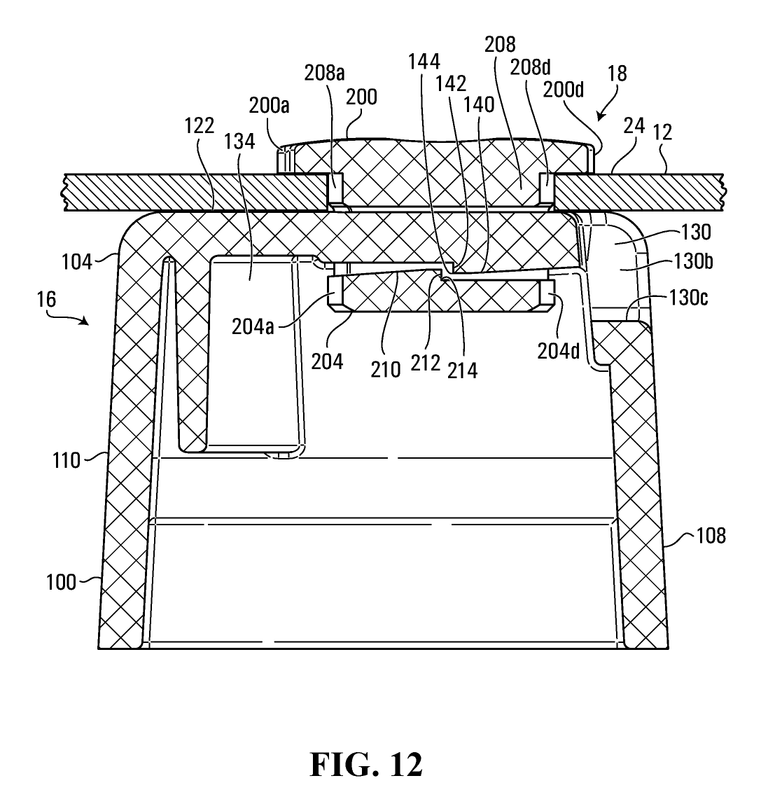

With reference to FIG. 12, the contact and co-operating surfaces of the above-described embodiments of the locking members 18 and 20 and the bracket 16 will be described in greater detail. For simplicity, the contact and co-operating surfaces of the locking member 18 and the bracket 16 will be described. However, it will be understood that the same applies correspondingly to the locking member 20 and the bracket 16.

In the embodiment shown, the locking member 18 is insertable through the aperture 22 in the container 12. Once inserted, the bracket 16 is slid in the first direction to engage the locking member 18. Because the point of engagement between the bracket 16 and the locking member 18 may be hidden under the rim 24 of the container 12, as a guide, the user may slide the upper wall 122 along the underside of the rim 24.

In the embodiment shown, the neck portion 208 is dimensioned to have a thickness approximately equal to the thickness of the container rim 24. Therefore, when the pin is inserted through aperture 22, substantially only the intermediate portion 206 and the end portion 204 protrude from the underside of the rim 24.

As the bracket 16 begins to engage the locking member 18, the slot opening 130 receives the front ends 204a and 206a of the pin 18.

The width W2 at the front opening of the slot opening 130 is dimensioned to be larger than the width W3 of the end portion 204 with a predetermined tolerance, such that the slot openings need not be precisely aligned with the end portions in order to successfully have the bracket 16 engage and slidably engage or receive the locking member 18. Moreover, the angled sides 130a and 130b have a guide function that aid in aligning the intermediate portion 206 to be received in the slot 128.

The thickness of the intermediate portion 206 and the thickness T of the upper wall 122 are dimensioned with a predetermined tolerance so that as the intermediate portion 206 engages the slot 128, the angled surface 140 begins to contact and act as a cam on the angled surface 210, urging the pin downward. However, due to the presence of the rim 24 of the container 12, the pin is unable to move downwards, causing the pin head 200 to exert a compressive force onto the rim 24. The thicknesses of the portions 204 and 206 of the pin, the thickness of the upper wall 122, and the height of the risers 142 and 212 are dimensioned relative to the thickness of the rim 24 such that at least some compressive clamping force is exerted on the rim 24 by the pin head 200 and the upper wall 122 in order for the risers 142 and 212 to clear each other as the bracket 16 continues to slide in the first direction. This compressive clamping force increases as the angled surfaces 140 and 210 slide relative to each other and reaches an apex when the risers 142 and 212 are co-planar.

Once the riser 142 has cleared and moved past the riser 212, the compressive force is released and the bracket 16 assumes the locking position. The bracket 16 is prevented from moving in a second direction, opposite the first, i.e. in reverse of the sliding direction because the blocking surface 142 and the locking surface 214 would interfere with each other. In particular, if the user attempts to slide the bracket 16 back in the second direction, the blocking surface 142 will abut and contact the locking surface 214, preventing movement of the bracket in the second direction.

In the embodiment shown, in the locking position, the bracket 16 is also prevented from continued movement in the first direction. Namely, if attempted, the front end 206a will abut and interfere with the rear wall 128c.

If the bracket 16 is moved vertically, i.e. in a third direction, perpendicular to the first and a sufficient compressive force is exerted on the rim 24, the locking element and blocking elements are separable. Thus, the bracket 16 may be brought into an unlocked position where there is sufficient clearance between the risers 140 and 212 to allow the bracket 16 to be slid back out in the second direction.

The components of the system according to the present disclosure may be manufactured in variety of ways known to a person skilled in the art and may be made of different materials known to a person skilled in the art. In one embodiment, each of the locking members and the bracket are manufactured as a single unit, for example, by injection moulding a thermoplastic. However, the components, particularly the bracket, may comprise multiple separate parts that have been assembled to form the bracket. Each of the components may also be made of other suitable materials, such as metals, particularly steel.

As will be understood, the manufacturing method of the components depends in part on their configuration. For example, if the contact between the locking members and the bracket is provided by a spring-loaded mechanism, assembly will be required and the components would be manufactured from a mixture of materials, such as thermoplastics and steel.

What has been described is merely illustrative of the application of principles of embodiments of the present disclosure. Other arrangements and systems can be implemented by those skilled in the art.

We claim:

1. A system for connecting adjacent waste or recycling containers to each other, the system comprising:
a bracket and at least one locking member associated with the containers, wherein the bracket is slidable in a first direction to slidably engage the at least one locking member until the bracket reaches a locking position, and wherein, in the locking position, contact between co-operating surfaces of the at least one locking member and the bracket prevents movement of the bracket in at least a second direction opposite the first direction

2. The system of claim 1, wherein the bracket is slidable to slidably receive the at least one locking member.

3. The system of claim 1, wherein the at least one locking member comprises at least two locking members, each container being associated with a respective one of the at least two locking members.

4. The system of claim 1, wherein the co-operating surfaces are defined on at least one locking element of the at least one locking member and on at least one blocking element of the bracket.

5. The system of claim 4, wherein the at least one locking element protrudes from the at least one locking member and wherein the at least one blocking element protrudes from the bracket.

6. The system of claim 4, wherein the co-operating surfaces include a locking surface on each of the at least one locking element and a respective blocking surface on each of the at least one blocking element, the locking surface abutting the respective blocking surface to prevent the movement of the bracket.

7. The system of claim 4, wherein the at least one locking element and the at least one blocking element comprise teeth that engage with each other in the locking position to prevent movement of the bracket.

8. The system of claim 4, wherein the at least one locking element each comprise a stepped ramp with an angled tread and a riser.

9. The system of claim 4, wherein the at least one blocking element each comprise a stepped ramp with an angled tread and a riser.

10. The system of claim 4, wherein the at least one locking member comprises at least two locking members, each locking member comprising a pin with a head and a pin body extending from the head, wherein the at least one locking element is disposed on the pin body.

11. The system of claim 10, wherein the pin body is insertable through a respective aperture in the container in a plurality of orientations and wherein the bracket is slidable into the locking position in only one of the plurality of orientations.

12. The system of claim 10, wherein the pin body comprises an end portion distal from the head and an intermediate portion between the end portion and the head, wherein the end portion has a first width transverse to the first direction and the intermediate portion has a second width transverse to the first direction, wherein the first width is larger than the second width, and wherein the at least one locking element is disposed on the end portion.

13. The system of claim 1, wherein the bracket comprises at least one slot to receive the at least one locking member, and wherein the at least one blocking element is arranged adjacent to the at least one slot.

14. The system of claim 13, wherein the at least one slot comprises at least two slots, wherein the bracket comprises a base and two extensions extending from opposing ends of the base to define a channel, and wherein each extension comprises at least one of the at least two slots.

15. A bracket for use in connecting adjacent waste or recycling containers to each other, the bracket comprising:
at least one slot extending in a first direction, the at least one slot for slidingly receiving at least one respective locking member associated with the containers until the bracket reaches a locking position; and
at least one blocking element disposed on the bracket, the at least one blocking element defining at least one blocking surface for contacting at least one respective locking surface of the at least one locking member.

16. The bracket of claim 15, further comprising a base having two opposing ends and an extension extending from each of the opposing ends to define a channel therebetween, wherein the at least one slot comprises at least two slots, wherein each extension comprises at least one of the at least two slots, and wherein at least one blocking element is arranged adjacent each of the at least two slots.

17. The bracket of claim 15, wherein the at least one blocking element protrudes from the bracket.

18. The bracket of claim 15, wherein the at least one blocking surface is for abutting the respective at least one locking surface to prevent movement of the bracket in a second direction opposite the first direction.

19. The bracket of claim 15, wherein the at least one blocking element each comprises a tooth for engaging a respective tooth of the at least one locking element in the locking position.

20. The bracket of claim 15, wherein the at least one blocking element each comprises a stepped ramp having an angled tread extending in the first direction and a riser.
